(19) United States
(12) Patent Application Publication
(10) Pub. No.: US 2016/0164766 A1
(43) Pub. Date: Jun. 9, 2016

(54) DATA POLLING SYSTEM AND METHOD FOR HANDHELD DEVICE

(71) Applicants: Inventec (Pudong) Technology Corporation, Shanghai (CN); Inventec Corporation, Taipei City (TW)

(72) Inventor: LONG CHEN, Shanghai (CN)

(21) Appl. No.: 14/663,221

(22) Filed: Mar. 19, 2015

(30) Foreign Application Priority Data
Dec. 4, 2014 (CN) 201410729322.X

(51) Int. Cl. H04L 12/26; H04W 24/08; H04W 4/00; H04L 29/08

(52) U.S. Cl. CPC H04L 43/10; H04L 67/025; H04W 24/08; H04W 4/003

(57) ABSTRACT

A data polling system and method for a handheld device are provided, where a server is used to receive an execution instruction or an newly data and set a polling time according to the execution instruction or the newly data so that the polling time is dynamically adjusted according to different execution operations, in such a manner that the handheld device may perform a polling data updating by its application program so that resource consumption may be reduced and the updated data may be acquired on line with respect to the application program.

### CROSS-REFERENCE TO RELATED APPLICATION

This application claims the benefit of Chinese Patent Application No. 201410729322.X, filed Dec. 4, 2014.

### BACKGROUND OF THE RELATED ART

1. Technical Field

The present invention relates to a data polling system and method, and particularly to a data polling system and method for a handheld device.

2. Prior Art

In applications, data updating is typically undertaken through a polling process, and the data updating in the manner may be obtained with online updated data, so that a user may be assured with the online data to facilitate a succeeding operation and processing for the user.

When the application program uses the polling manner for its data updating in the handheld device, the frequent polling may cause an exceeding power consumption and an overly data transmission amount. On the other hand, if the polling frequency is not enough, the user may not acquire the desired data on line, lending to a failure to a further operation and processing.

In view of the above, it may be known that there has long been the problem where the handheld device may have an exceeding resource consumption or the data may not be acquired on line in updating data by using the polling fashion. In response, there is quite a need to set forth an improvement means to settle down this problem.

### SUMMARY

In view of the problems encountered in the prior art where resource consumption is exceedingly large or data may not be acquired on line, the present invention provides a data polling system and method for a handheld device.

According to the present invention, the data polling system for a handheld device, comprising an application program, installed in the handheld device for transmitting an execution instruction and receiving and displaying a updated data; and a server, comprising a receiving module, receiving the execution instruction from the application program, and receiving a newly data; an instruction generating module, generating a polling time according to the execution instruction or the newly data; a generating module, generating an updated data according to the newly data; and a polling module, transmitting the updated data to the application program according to the polling time when the generating module generates the updated data.

According to the present invention, the data polling method for a handheld device, comprising steps of providing the handheld device with an application program installed therein; transmitting an execution instruction to a server by the application program; receiving a newly data by the server; generating a polling time by the server according to the execution instruction or the newly data; generating the updated data according to the newly added data when the server receives the newly data, and transmitting the updated data to the application program by the server according to the polling time and displaying the updated data by the application program, when the server generates the updated data.

The system and method of the present invention have the difference as compared to the prior art that the server is used to receive the execution instruction or the newly data and set the polling time according to the execution instruction or the newly data so that the polling time is dynamically adjusted according to different execution operation, in such a manner that the handheld device may perform a polling data updating by its application program so that resource consumption may be reduced and the updated data may be acquired on line with respect to the application program.

By using the technical means, the present invention may achieve in the efficacies where resource consumption is exceedingly large or data may not be acquired on line in the course of polling data updating for the handheld device.

### BRIEF DESCRIPTION OF THE DRAWINGS

The present invention will be better understood from the following detailed descriptions of the preferred embodiments according to the present invention, taken in conjunction with the accompanying drawings, in which:

FIG. 1 is a system block diagram of a data polling system for a handheld device according to the present invention;

FIG. 2 is a flowchart of a data polling method for the handheld device according to the present invention;

FIG. 3 is a system architecture diagram of the data polling system for the handheld device according to the present invention;

FIG. 4A is a schematic diagram of an application interface of the data polling system for the handheld device according to the present invention; and

FIG. 4B is a schematic diagram for illustrating a display of an updated data for the data polling task in the handheld device according to the present invention.

### DETAILED DESCRIPTION

The present invention will be apparent from the following detailed description, which proceeds with reference to the accompanying drawings, wherein the same references relate to the same elements.

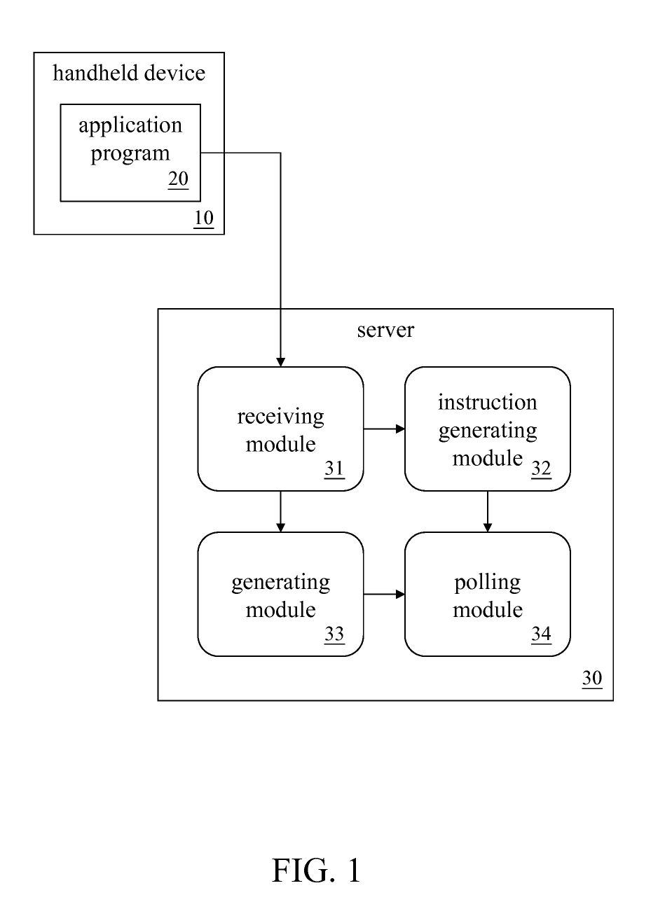

In the following, a data polling system for a handheld device of the present invention will be illustrated with reference to FIG. 1. FIG. 1 is a system block diagram showing the data polling system for the handheld device according to the present invention.

The data polling system for the handheld device comprises a handheld device 10, an application program 20 installed in the handheld device 10 and a server 30. The server 30 further comprises a receiving module 31, an instruction generating module 32, a generating module 33, and a polling module 34.

The handheld device 10 may be a smart mobile phone, a tablet computer, a personal digital assistant (PDA), and so on. However, these are merely examples without limiting the present invention.

When a user executes the application program 20 on the handheld device 10, the user may launch and operate the application program 20 and these may both generate a corresponding execution. The application program 20 may establish a connection with the server 30 through a cable connection manner, such as the cable network, or a wireless connection policy, such as the wireless network, such as wireless network and Wi-Fi. Through the network, the application program 20 may transmit the execution instruction to the server 30. The mentioned instruction may be an “ascertain instruction”, a “login instruction”, etc. However, these are merely examples.

The server 30 may receive the execution instruction at its receiving module 31 from the application program 20. Thereafter, the generating module 32 generates a polling time based on the instruction from the server 30 according to the execution instruction. Specifically, assume the receiving module 21 of the server 30 receives the execution instruction “login instruction” from the application program 20, and the polling time generated by the generating module 21 at the server 30 according to the execution instruction “login instruction” is “10 minutes”. However, these are merely examples without limiting the present invention.

It is to be noted that the instruction generating module 31 at the server 30 generates different polling time according to different execution instruction and a system time (herein the system time of the server 30) range. Specifically, assume the execution instruction is the “login instruction” and the system time range is “9:00 to 18:00”, then the polling time generated by the instruction generating module 31 at the server 30 is “10 minutes”. Assume the execution instruction is the “ascertain instruction” , and the system time range is “9:00 to 18:00”, then the polling time generated by the instruction generating module 31 at the server 30 is “5 minutes”.

Assume the execution instruction is the “login instruction”, and the system time range is “the system time excluding 9:00 to 18:00”, then the polling time generated by the instruction generating module 31 at the server 30 is “30 minutes”. Assume the execution instruction is the “ascertain instruction” , and the system time range is “the system time excluding 9:00 to 18:00”, then the polling time generated by the instruction generating module 31 at the server 30 is “20 minutes”. However, these are merely examples, without limiting the present invention.

Thereafter, the receiving module 31 at the server 30 receives a newly data from an electronic device or another application program, in which the newly data may be a signature and approve form, an email, and the like. However, these are merely examples without limiting the present invention. The mentioned electronic device may be a desktop computer, a notebook computer, a tablet computer, a smart phone, etc. However, these are merely examples without limiting the present invention.

Thereafter, the generating module 33 at the server 30 may generate an updated data according to the newly data. At the same time, the instruction generating module 32 at the server 30 may generate a polling time according to the newly data.

Thereafter, the polling module 34 at the server 30 transmits the updated data to the application program 20 according to the polling time when the updated data is generated by the generating module 33 at the server 30. Specifically, assume the generating module 33 at the sever end 30 generates the updated data and the instruction generating module 32 at the server 30 may generate the polling time as “3 minutes” according to the newly data, then the polling module 34 at the server 30 may transmit the updated data to the application program 20 after 3 minutes, i.e. the polling time, the updated data can be displayed by the application program 20.

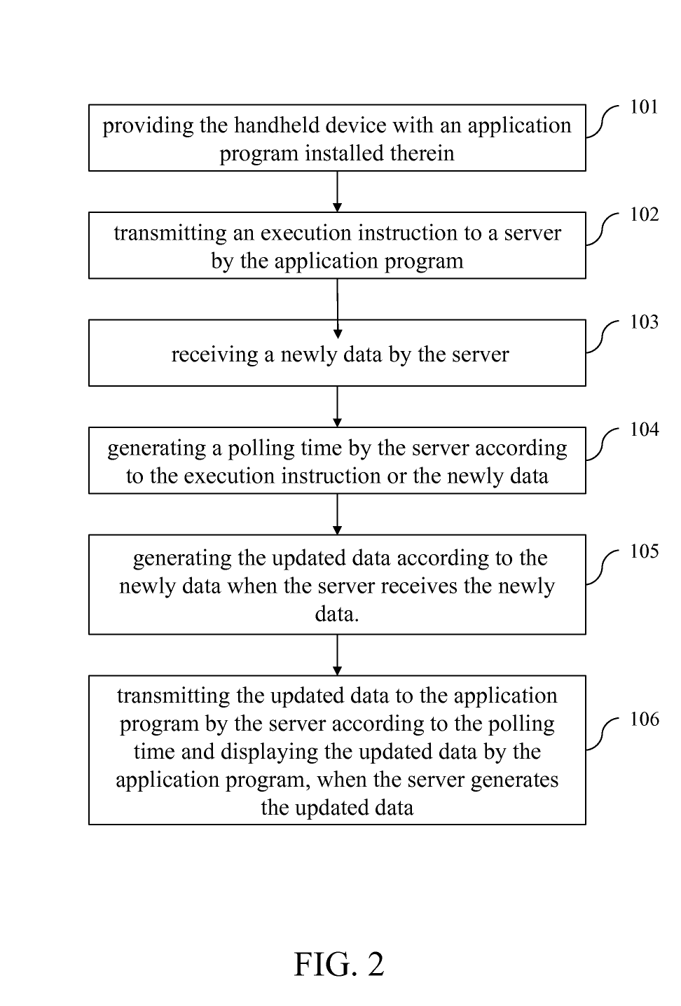

Thereafter, an embodiment will be exemplified to explain how the present invention operates with reference to FIG. 1 and FIG. 2, in which FIG. 2 is a flowchart of a data polling method for the handheld device according to the present invention.

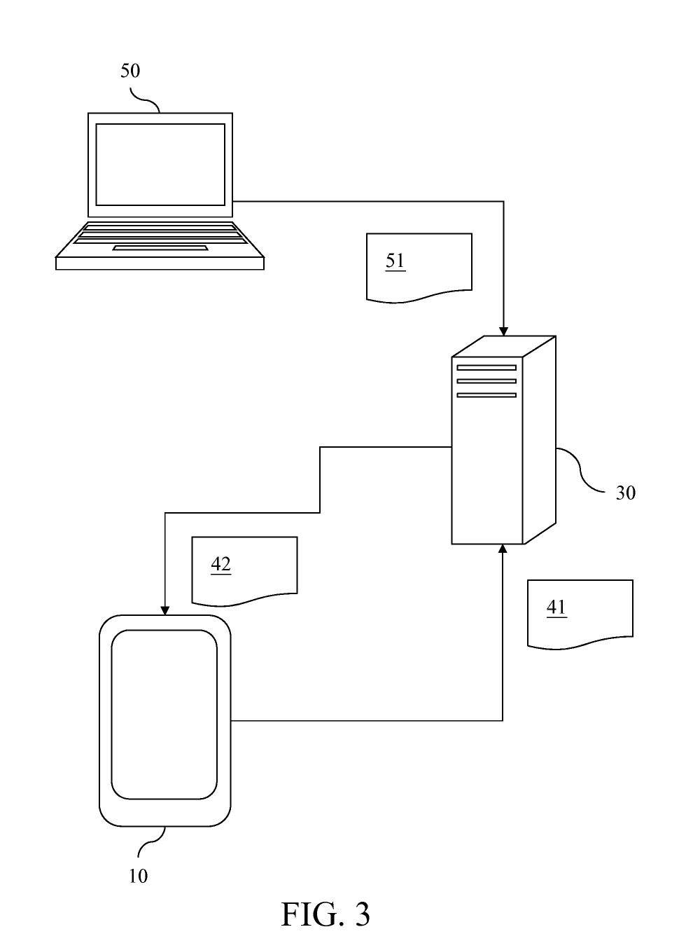

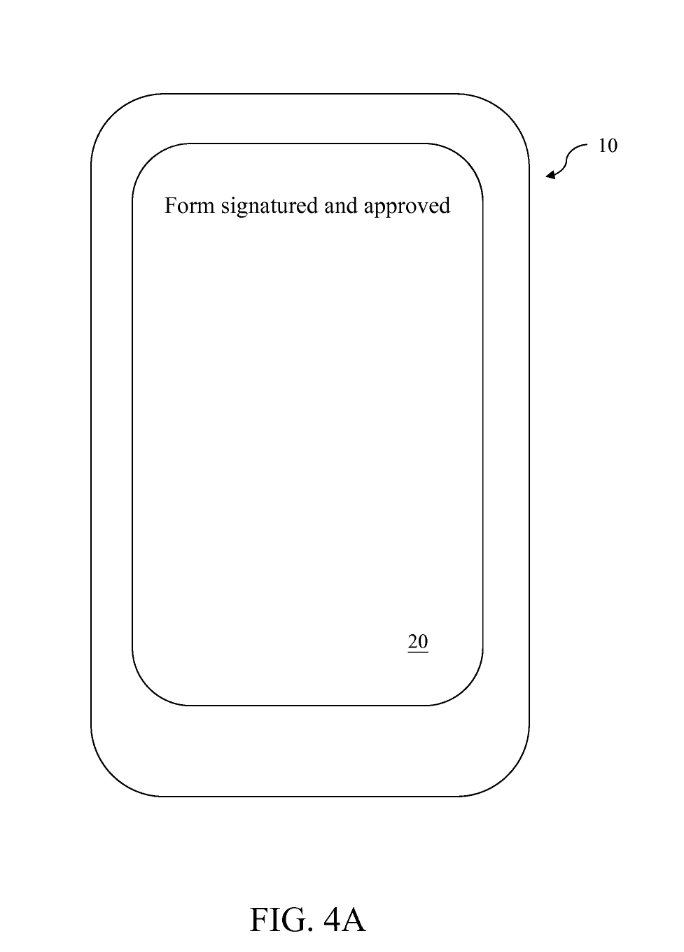

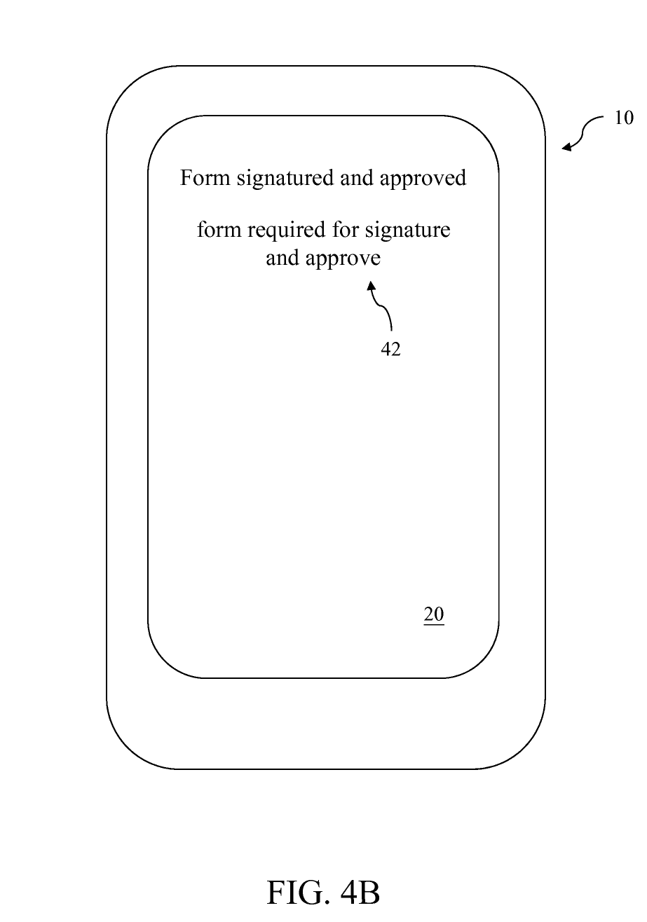

Refer to FIG. 3 and FIGS. 4A through FIG. 4B simultaneously, in which FIG. 3 is a system architecture diagram of the data polling method for the handheld device according to the present invention, FIG. 4A is a schematic diagram of an application interface for the data polling method for the handheld device according to the present invention, and FIG. 4B is a schematic diagram of an updated data display for a data polling for the data polling method for the handheld device according to the present invention.

As shown in FIG. 4A, when the user executes the application software 20 installed in the handheld device 10 (S101) and launches an updating operation on the application program 20 by which the execution instruction 41 “updating operation” corresponding thereto is generated, the application program 20 may establish a connection with the server 30 through Wi-Fi and transmit the execution instruction 41 “updating operation” to the server 30 (S102). However, this is merely an example, without limiting the present invention.

Thereafter, the server 30 receives the execution instruction 41 “updating operation” from the application program 20 at its receiving module 31. In this embodiment, the system time of the server 30 is “10:00”, and thus the instruction generating module 32 at the server 30 generate the polling time as “5 minutes” according to the execution instruction 41 “updating operation” and the system time“10:00” (S104).

Thereafter, the receiving module 31 at the server 30 receives the newly data 51 “signature and approve form” from the electronic device 50 (S103). However, this is merely an example without limiting the present invention. Then, the generating module 33 at the server 30 generates the updated data 42 as “form presented and signature and approve required” according to the newly data 51 “signature and approve form” (S105). At the same time, the instruction generating module 32 at the server 30 generates the polling time as “3 minutes” according to the newly data 51 “signature and approve form” (S104).

Thereafter, the instruction generating module 32 at the server 30 will generate the polling time as “3 minutes” according to the newly data 51, and then the polling module 34 at the server 30 may transmit the updated data 42 as “form presented and signature and approve required” to the application program 20 after 3 minutes. In response, the application program 20 displays the updated data 42 as “form presented and signature and approve required” (S106), in which the updated data has its display result shown in FIG. 4B.

In view of the above description, it may be known that the present invention have the difference as compared to the prior art that the server is used to receive the execution instruction or the newly data and set the polling time according to the execution instruction or the newly data so that the polling time is dynamically adjusted according to different execution operations, in such a manner that the handheld device may perform a polling data updating by its application program so that resource consumption may be reduced and the updated data may be acquired on line.

By using the technical means, the present invention may well solve the problems encountered in the prior art where resource consumption is exceedingly large or data may not be acquired on line in the course of polling data updating for the handheld device, and may further achieve in the efficacies of reduced resource consumption and online data updating in the course of data polling in the application program on a handheld device.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A data polling system for a handheld device, comprising:
an application program, installed in the handheld device for transmitting an execution instruction and receiving and displaying a updated date; and
a server, comprising:
a receiving module, receiving the execution instruction from the application program, and receiving a newly data;
an instruction generating module, generating a polling time according to the execution instruction or the newly data;
a generating module, generating an updated data according to the newly data; and
a polling module, transmitting the updated data to the application program according to the polling time when the generating module generates the updated data.

2. The data polling system for the handheld device as claimed in claim 1, wherein the receiving module receives the newly data from an electronic device.

3. The data polling system for the handheld device as claimed in claim 1, wherein the instruction generating module generates different the polling time according to different the execution instruction and different a system time range.

4. The data polling system for the handheld device as claimed in claim 1, wherein the receiving module receives the newly date from the application program.

5. A data polling method for a handheld device, comprising steps of:
providing the handheld device with an application program installed therein;
transmitting an execution instruction to a server by the application program;
receiving a newly data by the server;
generating a polling time by the server according to the execution instruction or the newly data;
generating the updated data according to the newly data when the server receives the newly data; and
transmitting the updated data to the application program by the server according to the polling time and displaying the updated data by the application program, when the server generates the updated data.

6. The data polling method for the handheld device as claimed in claim 5, wherein the server receives the newly data from an electronic device.

7. The data polling method for the handheld device as claimed in claim 5, wherein generating the polling time by the server according to different the execution instruction and different a system time range.

8. The data polling method for the handheld device as claimed in claim 5, wherein the server receives the newly from the application program.
